(19) United States
(12) Patent Application Publication
(10) Pub. No.: US 2007/0036295 A1
(43) Pub. Date: Feb. 15, 2007

(54) Telephone Index Device

(76) Inventor: Howard Brian Work, Ottawa (CA)

Correspondence Address: HOWARD BRIAN WORK, 1833 BEATTLE AVENUE, OTTAWA, ON, K1H-5R7, CA

(21) Appl. No.: 11/161,000

(22) Filed: Jul. 19, 2005

(51) Int. Cl. H04M 1/64

(52) U.S. Cl. 379/88.19

(57) ABSTRACT

A database containing an array of phone numbers.

The present invention pertains to an index device for use with residential phones. The Index device will keep a list of the owners personal contact phone numbers. The callers will have to verify they are a personal contact by entering their phone number when calling the owner's residence.

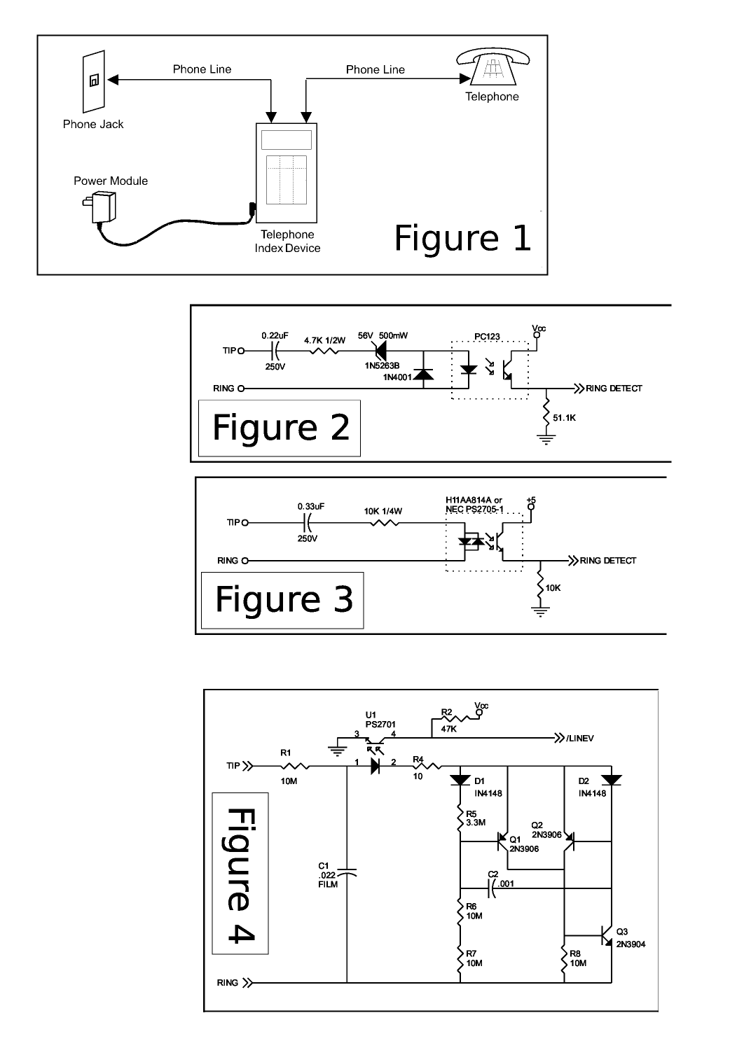

The Index Device is interposed on the line between the telephone and the telephone wall jack, as illustrated in FIG. 1. The Index Device receives its power from an inexpensive, standard commercially available power module (for example, a Tamura 318AS12030) When a call is received, the Index Device detects the incoming ring signal and quickly disconnects the attached telephone. The disconnect is done rapidly enough to prevent the telephone's ringer from sounding and disturbing the owner.

After the first ring burst completes, the Index Device takes the phone line off hook. In an alternative embodiment, the Index Device takes the phone line off hook immediately upon detection of the leading edge of the ring signal, inserting only enough delay to ensure the telephone system does not regard the line as being already off-hook and thus passing a busy signal back to the caller. By applying this “fast-answer” technique, ringing of other telephones on the line can be held to a fleeting “chirp” or “ding” if not eliminated entirely, thus making the Index Device effective at minimizing the disturbance from unscreened calls, for example, throughout an entire household, even though the Index Device is plugged into the phone line at only one location in the house.

Once the Index Device has taken the line off hook, it plays a voice message to the caller, prompting the caller to enter a sequence of digits established as the caller's phone number. If the caller enters an unrecognized sequence of digits, or after a reasonable time limit if the caller enters nothing at all, the device plays a suitable apology message and hangs up, terminating the call.

Upon successfully entering a string of digits that the device validates, the caller will hear a message indicating that his call has been accepted. The Index Device will then generate a ring signal to the attached telephone. In an alternative embodiment, the Index Device contains its own speaker or audio transducer and generates a ring sound with that rather than ringing the attached phone. This would reduce the cost of the device because the expensive circuitry required to generate a telephone ring signal would not be needed. While ringing the attached phone or producing a ring sound, the Index Device will also play a ring tone back to the caller. This will continue until A) the attached telephone is taken off-hook, B) the device detects that some other device on the line has gone off-hook, C) the device detects the caller has hung up, or D) a preset time has elapsed with no answer. In the event of A) or B), the device reconnects the attached telephone to the line, then goes on-hook itself, terminating its involvement with the call.

In cases where the telephone system provides a line-drop signal to indicate the caller has hung up, case C) can be applied where the Index Device detects this and hangs up itself. For D), the preset time should be longer than most callers are likely to wait on the line for a call to be picked up, for example: 3 minutes. If this time elapses without any of the other events being detected, the device stops ringing and hangs up the line, terminating the call.

The Index Device has a display and a keypad. These provide a means for the owner to view, add, edit and delete caller phone numbers. The Index Device will internally store a large number of such phone numbers. These will be retained even when power is removed. The manufacturer establishes the messages played by the Index Device only.

### DESIGN DESCRIPTION

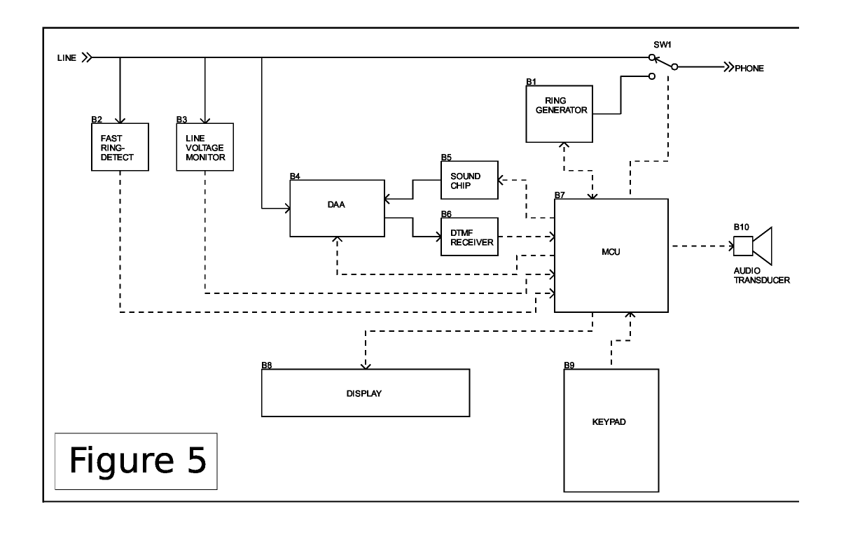

FIG. 5 is a block diagram depicting all the basic functions required to implement the Index Device.

B2 in FIG. 5 is a “fast ring detect” circuit, so called because conventional ring detector circuits are usually half-wave designs, and may therefore have a delay of half a cycle of the incoming ring signal before they respond. A typical ring detector circuit is shown in FIG. 2.

An embodiment of a fast ring detector is shown in FIG. 3. This circuit differs from the conventional ring detector firstly by the use of an AC-input type of opto-isolator and secondly by the elimination of the zener diode. By using the full-wave AC-type opto-isolator, the first half cycle of the ring signal will be detected regardless of its polarity. By eliminating the zener diode, the threshold effect it introduces is removed and the circuit can respond immediately to the leading edge of the ring signal rather than waiting until the leading edge climbs past the threshold level.

Block B3 in FIG. 5, the “Line Voltage Monitor” function, is an optional function required only if it is desired to implement event B) as described in the “Functional Description” section. If the ability to detect when a call is answered by a device on the phone line other then the attached telephone is not needed, then this functional block can be omitted, with a resultant reduction in cost. A preferred embodiment for the “Line Voltage Monitor” function is shown in FIG. 4.

This circuit converts the voltage between tip and ring into a pulse train on the LINEV output without violating FCC specifications for leakage current on an on-hook phone line. The higher the voltage on the line, the greater the frequency of the pulse train. By measuring the frequency of the pulses on LINEV, the voltage across the phone line can be determined. Block B4 in FIG. 5 is a DAA, or “Data Access Arrangement”. This is a standard function in telephony devices that provides line isolation, hook switch and 2-to-4-wire hybrid functionality. This can be embodied using discrete components typically including a transformer and relay, or with integrated circuits such as the Si3050 “Silicon DAA” from Silicon Labs or the CX20493 “SmartDAA” device from Conexant.

Some more sophisticated silicon DAAs, such as the Si2400 series from Silicon Labs, have the voltage monitoring capability built in. In the case of an embodiment using one of these chip sets, there would be no need to implement the Line Voltage Monitor function as a separate circuit.

Block B5, “Sound Chip”, is responsible for generating the voice messages that the Index Device can play into the phone line. The ISD1416 from WinBond Electronics or the HT81012 from Holtek Semiconductor are possible embodiments of this functional block. A preferred embodiment would be to select a slightly more powerful MCU (MicroController Unit, block B7) and program the voice-generating capability into it. In this case, the “Sound Chip” function would not be implemented as a separate circuit.

The DTMF Receiver block, B6, is responsible for receiving and deciphering the digits dialed by the caller. A preferred embodiment of this function would use an MT3271 manufactured by Zarlink Semiconductor. Given a sufficiently powerful MCU, this function could also be incorporated into the MCU rather than implemented as a separate circuit.

Block B7 is the MCU. It is programmed with firmware code that monitors and controls all the other functional blocks depicted in FIG. 5.

B1 represents the block of circuitry necessary for generating the ring signal required to sound the ringer on the attached phone. A device such as the UCC3751 from Texas Instruments, the HV449 from Supertex or the PCR-SIN06V12F00 from PowerDsine could be used to embody this function.

B10 is optional. It is a loudspeaker or piezo acoustic transducer that can be used to generate sounds. If included in the embodiment, it can be used to provide audible feedback to the user, for example, key clicks and error beeps, to aid in interaction with the device. If sufficiently loud, it could also be used to produce a ringing noise, making the Ring Generator block unnecessary and lowering the cost of the Index Device accordingly. B8 is an LCD character display of sufficient size to display phone numbers and menu prompts. B9 is a 12-button keypad similar in layout to a telephone dial. Together, these comprise the user interface to the device and provide the means to view, enter, edit and delete stored phone numbers.

What is claimed is:

1. The Telephone Index Device is easy to install and simple to operate.

2. The Telephone Index Device will allow the owner to automate his phone contacts and set his phone to receive calls only from those contact phone numbers listed in The Telephone Index Device.
